(19) United States
(12) Patent Application Publication
(10) Pub. No.: US 2013/0221089 A1
(43) Pub. Date: Aug. 29, 2013

(54) ELECTROLYTE-CONTAINING INFORMATION CARRIER

(71) Applicant: Andre Kreutzer, Mittweida (DE)

(72) Inventor: Andre Kreutzer, Mittweida (DE)

(73) Assignee: PRINTECHNOLOGICS GMBH, Chemnitz (DE)

(21) Appl. No.: 13/825,148

(22) PCT Filed: Sep. 20, 2011
(86) PCT No.: PCT/EP11/66346

§ 371 Date: May 9, 2013

Related U.S. Application Data
(60) Provisional application No. 61/384,489, filed on Sep. 20, 2010.

(30) Foreign Application Priority Data
Sep. 20, 2010 (EP) 10075487.8

(51) Int. Cl. G06K 19/02; G06K 19/067; G06K 1/12

(52) U.S. Cl. CPC G06K 19/02; G06K 1/128; G06K 19/067; G06Q 10/0833
USPC 235/375; 427/80; 235/492

(57) ABSTRACT

The invention describes and information carrier comprising an electrically non-conductive substrate to which an electrolyte is applied to certain regions.

The invention relates to an information carrier comprising at least one electrolyte and one substrate, wherein the substrate is an electrically non-conductive layer and is covered by the electrolyte in certain areas. The invention further relates to the use of the information carrier and the production thereof.

The prior art discloses a plurality of possibilities to produce information carriers by means of printing technologies or other coating methods, which information carriers can be read by means of suitable reading methods or readers. The probably most common information carriers produced in such a manner are barcodes in the embodiment as a one-dimensional barcode or, for example, as two-dimensional variants. They are acquired with suitable optical scanners and, if required, further processed via adequate data processing systems.

The printing technologies and coating technologies for producing such features likewise continue to develop. Thus, EP 1 803 562 describes a method for transferring imaging layers from one carrier film or transfer film onto print sheets in a sheet-processing machine. Here, an adhesive is applied in a first application station and is brought together with a transfer film in a further coating station, and material from the transfer film is applied onto the print sheet by means of adhesion. In the process of this, a transfer gap is formed in the application station, and along the surface of a press roll, the transfer film is placed with the side that is coated with transfer material onto a print sheet, and is fed under pressure together with the print sheet through said transfer gap so that the imaging layers are transferred in areas covered with adhesive from the carrier film onto the print sheet so as to adhere thereon. With this, barcodes and alphanumeric information can be readily applied.

Furthermore, in the prior art, flat printed materials are disclosed in U.S. Pat. No. 5,818,019, U.S. Pat. No. 3,719,804, U.S. Pat. No. 4,587,410 and US 2006/0118612, which materials allow a secure verification or validation of data. This can make sense for drugs and their packaging, but also for lottery tickets. The printed information ensure, e.g., authentication or serve as a validity check. Also, capacitively readable information carriers are known from the applications U.S. Pat. No. 3,719,804 (permanent information store) and U.S. Pat. No. 4,587,410 (parking system), amongst others. In the last-mentioned example, processing and changeability of capacitive structures for a parking meter are illustrated. By means of a mechanical unit, the capacitive structure in the reader is successively changed and thus its “inner value” is changed. Individualization of the structures is not provided. The complete system is an autarkic system without interaction with other systems or data processing or data storage. In U.S. Pat. No. 3,719,804, the production possibilities by means of printing technologies such as, for example, screen printing, flexo printing and gravure printing are listed. Individualization is carried out by means of separation techniques of the applied conductor tracks. The reading method is greatly position-dependent and is associated with a fixed reading position of the information carrier in the reader.

DE 20 2006 013 070 U1 discloses a method and means for generating structures from functional materials that can be used, for example, for playing cards, wherein the playing cards have a code arrangement that can be visualized by a computer. In the document DE 10 2008 013 509 A1, a steganographic method is illustrated which can generate security features in printed products by means of transfer film technology. Verifying the features takes place optically by means of decoders. Furthermore, a security feature is known from DE 102006031795A1 which has been generated by means of transfer film technology. In this method, resistors or resistor networks are introduced in printed products which shall serve as a security feature. Verification takes place through contact by means of a reader which measures the resistances according to the ohmic principle.

Furthermore, WO 2004/070501 discloses a system that allows tracking an article (e.g. clothing). Here, an arbitrary code is integrated on the textile material of the article, which code subsequently enables detecting or identifying the article.

DE 101 09 221 discloses a data carrier that has an electromagnetic coupling element by means of which data and/or energy can be transferred, wherein the coupling element consists of conductor tracks and electrolyte that are applied onto a carrier film. The electrodes of the conductor tracks are electrochemically connected through the electrolyte.

Disadvantages of the prior art are, for example:
Individualizing is relatively costly; the information carriers often receive an individualization of their information in downstream process steps.
Capacitively readable information layers/information carriers according to the prior art are visible or easily detectable, which is hindering in applications in which this is in conflict with the intended use (copy protection, payment or access systems, etc.).
Environmentally friendly only to a limited extent; often, solvent-containing conductive adhesives and paints and/or non-compostable metals are used.
Relatively high material costs incur due to multi-stage methods, drying and/or dwell times.
Relatively cost-intense.
Relatively susceptible to bending and especially buckling.
Only high-volume productions are profitable; low- and medium-volume productions are uneconomical.
Substrates must not be too absorbent or rough; this disturbs/destroys the conductive layers resulting in failures.
Electrodes are required for conducting.

Based on this prior art, it is an object of the present invention to provide a data carrier which does not exhibit the disadvantages and deficiencies of the prior art and which enables storing of information.

The object is achieved by the independent claims. Advantageous embodiments arise from the sub-claims.

It was completely surprising that an information carrier can be provided that does not exhibit the disadvantages of the prior art, wherein the information carrier comprises at least one electrolyte and one substrate, and the substrate is an electrically non-conductive layer and the electrolyte is applied on and/or introduced in the substrate in certain areas. Surprisingly, the information carrier according to the invention is able to interact with a device comprising an area sensor, wherein the information carrier preferably is capacitively readable. The information carrier is environmentally friendly and is no burden on the environment. Moreover, it can be produced in a cost-effective manner and is advantageously also suitable for mass-production methods.

In the meaning of the invention, an area sensor can also be designated as touch-sensitive screen and is also known as touchscreen. Devices containing area sensors comprise, for example, smartphones, cell phones, displays, tablet PCs, tablet notebooks, touchpad devices, graphics tablets, television sets, PDAs, MP3 players, trackpads and/or capacitive input devices. Such an area sensor, for example, can also be an integral part of input devices as a touchscreen, touchpad or a graphics tablet. Touchscreens are also known as tactile screens or touch-sensitive screens. Such input devices are used in smartphones, PDAs, touch displays or notebooks, amongst others.

The electrolyte is preferably applied on or introduced in the substrate in certain areas in a layer, in particular a structured layer. It is known to the person skilled in the art that a fluid can diffuse or penetrate, for example, into a substrate, wherein the fluid can also be present on the substrate. The electrolyte can be present in a structured manner, in particular as a structured electrolyte layer.

In a preferred embodiment, the electrolyte is a printed layer on the substrate. It was completely surprising that the electrolyte can be applied on the substrate by means of a printing method. This is a significant advantage over the prior art since through this, the information carrier can be produced using mass-production methods. Advantageously, the layer can be implemented with an additive method in an easy and economically favorable manner. However, it is also preferred that the electrolyte is transferred onto the substrate by means of a transfer method. According to the invention, applying the electrolyte onto the substrate can be carried out with transfer methods known per se; this preferably concerns the transfer film method and particularly preferred a cold film transfer method. Such methods are known to the person skilled in the art and he/she knows that it is possible to apply a substance (such as, e.g., an electrolyte) in structured manner, in particular in certain areas, onto a substrate by means of printing methods. Here, the substrate is not covered over the entire surface by the electrolyte, but the electrolyte is present only in or on certain areas of the substrate. Of course, other methods for applying a layer in a structured manner can also be used.

According to another preferred embodiment, the electrolyte layer is implemented by using a subtractive method, wherein layer areas are removed. For this purpose, known etching or laser ablation methods are used. In the latter case, the material to be removed is vaporized through the action of the laser beams. Of course, further methods can also be used.

Advantageously, the applied or introduced electrolyte can be altered in certain areas in particular in terms of its structuring by means of additive and/or subtractive methods, preferably by inkjet methods and particularly preferred by laser methods. However, it is also preferred that the information carrier is produced by means of a printing method known to the person skilled in the art, preferably an additive and/or subtractive method.

In the meaning of the invention, the electrolyte designates in particular a chemical compound that is present in solution or liquefied material and is dissociated into ions. These substances comprise acids, bases and salts. In water or water-like solvents, dissociation into ions is not always complete so that based on the dissociation equilibrium position, weak electrolytes (not completely dissociated) and strong electrolytes (completely dissociated even in a concentrated solution) can be differentiated from each other. The presence of electrolytes is the prerequisite for all electrolyte processes, for many osmosis processes, for maintaining the acid-base equilibrium in animal organisms, for the mineral metabolism of plants and for the provision of plant nutrients in the soil. In the technical field, electrolytes play a role as a flocculant and a salting-out agent due to their salt effects.

The so-called ampholytes and the polyelectrolytes have a special position within the electrolytes. Ampholytes designate in particular amphoteric electrolytic compounds that have acidic as well as basic hydrophilic groups and thus, depending on the conditions, exhibit an acidic or basic behavior. Ampholytes comprise, for example, aliphatic polyamines with carboxy, sulfo or phosphono side chains. Polyelectrolytes designate in particular ionic polymers with a large number of ionically dissociable groups which can be an integral part of the polymer main chain or are laterally linked thereto. It is preferred that the electrolyte is solid, liquid, gel-like or pasty.

The electrolyte is preferably structured as a point, dash, curve, area and/or combinations thereof and is applied onto the substrate or is present therein. The person skilled in the art understands according to the disclosure of the present invention that the applied electrolyte forms corner points and/or fill areas defined by curves, for example, rectangles, circles or similar figures. The spatial relations of the subareas to each other (orientation, quantity, alignment, distance and/or position) and/or the shape of the subareas preferably represent information. It is preferred that the structured electrolyte present on or in the substrate is detected, acquired and processed in terms of data by an area sensor and/or a device containing an area sensor.

The area sensor preferably acts analogous to a capacitive reader, but without being dependent in terms of hardware on fixed, predefined conductor paths or reading electrodes as they are currently limitingly known from the prior art (U.S. Pat. No. 3,719,804—Permanent information store). Through the information carriers according to the invention, an extension of the range of functions of devices containing capacitive area sensors opens up. As a result, for example, access to information is made easier and/or the use of the devices is simplified (especially for physically handicapped, disabled or elderly persons) and/or new applications are enabled, without being limited thereto.

The person skilled in the art knows processes and methods to read such conductive layers that are present on a substrate in a structured manner. In the prior art, numerous processes and methods are disclosed that describe storing of information by means of printing methods and also explain how the information can be read (e.g., U.S. Pat. No. 3,719,804). The information carrier according to the invention can advantageously be read through capacitive coupling by bringing the information carrier in operative contact with an area sensor or a reader. In the meaning of the invention, an operative contact describes bringing the information carrier close to the area sensor so that an action on the area sensor is achieved by the information carrier. Bringing the information carrier close designates in particular a distance between the information carrier and the area sensor of from 0 cm to 50 cm.

Preferably, information is stored on the information carrier in the form of the structure or layer applied thereon, which can be configured as a subarea. The information is readable when the information carrier contacts or approaches the area sensor or reader. The layer or structure forming the information, i.e., the subareas of an area, consists of the electrolyte applied on or introduced in the substrate.

Furthermore, it is preferred that the structured electrolyte is read by a reading device, the electrode arrangement of which is configured and arranged such that the number, size, shape and/or position of the structured electrolyte of the information carrier is detected, acquired and processed in terms of data. The information carrier is preferably read capacitively. When positioning the information carrier at an area sensor or in a capacitive reader, the applied structure is interpreted so that from the subareas of the structure, encoded information can be determined, for example in the form of a binary coded number. However, an information carrier can also be directly interpreted as information carrier. Positioning can also be carried out through a movement of the information carrier relative to the area sensor. It is preferred that the area sensor, in a movement relative to the information carrier, progressively receives complete or partial information from the information carrier. In this connection, it is also possible that different events are generated in dependence on the positions of the information carrier with respect to the area sensor. Essential for this is, for example, the direction of movement or the residence time of the information carrier with respect to the area sensor.

In the meaning of the invention, an area sensor, in particular a capacitive area sensor, is a physical interface for acquiring electrical capacitances and/or capacitance differences within subareas of a defined area. Devices containing area sensors comprise, for example, smartphones, cell phones, displays, tablet PCs, tablet notebooks, touchpad devices, graphics tablets, television sets, PDAs, MP3 players, trackpads and/or capacitive input devices. Such an area sensor, for example, can also be an integral part of input devices as a touchscreen, touchpad or a graphics tablet. Touchscreens are also known as tactile screens or touch-sensitive screen. Such input devices are used in smartphones, PDAs, touch displays or notebooks, amongst others. The information carrier, preferably in connection with an area sensor, can be assigned to an action of a data processing system or can trigger said action. An event in the meaning of the invention designates in particular something that triggers, preferably within applications, an action and thus a change of state. These events can be, for example, user inputs or system events.

Accordingly, a preferred use of the information carrier as an information storage is possible, wherein the information carrier is capacitively readable.

Furthermore, it is preferred that the information carrier is present as a security feature in or on a printed product. In the meaning of the invention, security features designate characteristic properties that prove the authenticity of an article. For example, banknotes and identification cards or passports comprise a plurality of these features. Apart from a holographic-cinematic feature, an identification card can also contain embossed surfaces and security printing features and watermarks. These features can be checked with chemical and physical methods, amongst others. It was completely surprising that the information carrier can also be integrated as a security feature in or on printed products. Printed products preferably comprise banknotes, books, payment means (e.g. credit cards), other printed elements (packaging, cards, newspapers, magazines) or tote bags, plastic containers, paper products, plastics, textiles, ceramics, metal, wood or glass. The information carrier introduced in or applied on these elements is not visible and thus can be used for authentication. Authenticity of the elements can be determined in a fast and simple manner by means of a reader or a device comprising an area sensor. Accordingly, it also preferred that the information carrier is used as a shipment tracking means, wherein the information carrier is printed inside or on the shipment to be tracked. This means, it is possible to print the information carrier as a tracking system onto packaging, for example, of a package to be shipped and to use the information carrier as a tracking system for tracking the package. For this purpose, a person who has sent the package could receive a 1-to-1 copy of the applied information carrier and read it with a reader or a device comprising an area sensor, and thus could be informed about the location of the package.

The invention also relates to a group of information carriers comprising a plurality of information carriers, wherein at least one paint layer, adhesive layer, paper layer and/or film is applied in each case at least as a background, cover, number, letter, symbol, graphic illustration and/or pictorial illustration or a combination thereof, wherein
a plurality of information carriers have an identical structure of the electrolyte and at least one identically configured paint layer so that a self-contained group of information carriers is implemented, which information carriers are identical in terms of information technology and optical appearance,
a plurality of information carriers have an identical structure of the electrolyte and at least one differently configured paint layer so that a group of information carriers is implemented, which information carriers are identical in terms of information technology, but are different in terms of optical appearance,
a plurality of information carriers have a different structure of the electrolyte and at least one identically configured paint layer so that a group of information carriers is implemented, which information carriers are unique in terms of information technology, but are identical in terms of optical appearance,
a plurality of information carriers have a different structure of the electrolyte and at least one differently configured paint layer so that information carriers are implemented that are unique in terms of information technology and optical appearance.

The group of information carriers can also be read in a reader or by means of a device comprising an area sensor. Advantageously, the group of information carriers can be combined with each other, wherein a plurality of information carriers can also be positioned one above the other or next to one another on an area sensor and can be read in this manner. In a preferred embodiment, the electrolyte is a salt selected from the group comprising inorganic and organic salts, double salts and/or complex salts.

In the meaning of the invention, a salt designates in particular a heteropolar compound in the crystal lattice of which at least one cation type that differs from hydrogen ions (protons) and at least one anion type that differs from hydroxide ions is involved. Inorganic salts (metal salts) are formed from the elements or during the reaction of metals, metal oxides, metal hydroxides or metal carbonates with acids or anhydrides, and during the reaction of metal salts among each other, or through redox reaction of metal salts with elements. Inorganic salts comprise, for example, 2AlCl₃, FeCl₂, MgSO₄, AlBr₃, Ca(NO₃)₂, Na₂CO₃, CuCl₂ or NaBr. Designated as reciprocal salt pairs are such salt pairs that react through double conversion thereby forming two other salts in which the ions are interchanged with respect to the initial salts, for example NaCl and KNO₃.

Also, ammonium ions (NH₄⁺) or the analogous organic ammonium compounds with quaternary nitrogen atoms, carbocations, sulfonium-, phosphonium-, diazonium- and other onium-compounds as well as organometallic complex cations such as ferrocenium can take the place of the metal ions.

Also, organic acid residues, e.g., of carboxylic acids, fatty acids and sulfonic acid or phenolate residues can function as anions in salts and form metal soaps in this manner. In order to be differentiated from the water-soluble sodium and potassium salts, the saturated and unsaturated natural and synthetic fatty acids, resin acids and naphthenic acids, the poorly water-soluble metal salts of these acids are designated as metal soaps (see table). The metal soaps have a melting point between 15 and 200° C. To some extent, they exhibit good solubility in fats and oils. Metal soaps are commercially available as a powder, dissolved in organic solvents, or as an aqueous dispersion. The most frequently used metal soaps are formulated with lithium, aluminum, magnesium, calcium, manganese, iron, zirconium, cerium, zinc, cobalt and vanadium as a cation.

TABLE
Classification of metal soaps

| | |
|---|---|
| neutral soaps | (R—COO⁻)₂M²⁺ or |
| | (R—COO⁻)₃M³⁺ |
| acidic soaps | (R—COO⁻)₂M²⁺•R—COOH or |
| | (R—COO⁻)₃M³⁺•R—COOH |
| basic soaps | (R—COO⁻)₃(M²⁺)₂•⁻OH |
| organic complex | (R¹—COO⁻)(R²—COO⁻)M²⁺ or |
| or mixed soaps | (R¹—COO⁻)(R²—COO⁻)(R³—COO—)M³⁺ |
| inorganic-organic | (R—COO⁻)₂(CO₃²⁻)(M²⁺)₂[(R—COO⁻)M²⁺O⁻]₃—X |
| complex and | |
| mixed soaps, | |
| respectively | |

M = metal ion;
R—COO⁻ = carboxylic acid residue;
X = e.g. phosphor or boron

Highly electrophilic cations form stable salts, e.g., [Hg(CO)₂][Sb₂F₁₁]₂, only with particularly weakly coordinating anions. Organic compounds, which in the same molecule have positively and negatively charged functional groups, can form so-called inner salts; example: betaines, sydnones and other zwitterions. One group of salts that plays a role in particular in pharmacology and the dye industry are adducts between acids and amines, alkaloids and other basic compounds, e.g., hydrohalogenides. Salts, in dependence on the inherent color of the ion type present in the salts, are colorless or colored.

When salt dissolves in water, it dissociates as electrolyte into cations and anions; example: sodium nitrate (NaNO₃) disintegrates in water into positively charged sodium ions and negatively charged nitrate ions (acid residue ions).

In the case of salts, a distinction is made between neutral (normal), acidic and basic salts. In the case of neutral salts, all ionizable hydrogen atoms of the acid (from which the salt derives) are replaced by other cations, or, respectively, all hydroxide groups of the base (from which the salts derives) are replaced by other anions. A large portion of the normal salts shows a neutral reaction in aqueous solution; however, salts can also react alkaline (e.g. trisodium phosphate, sodium carbonate, potassium carbonate, potassium cyanide) or acidic [e.g. iron(III) chloride, iron(II) sulfate, copper sulfate].

In the case of acidic salts, not all hydrogen atoms ionizable in aqueous solution are replaced by metal ions; example: sodium hydrogen carbonate (NaHCO₃) or sodium dihydrogen phosphate (NaH₂PO₄). Acidic salts often react acidic with litmus (but definitely not always); NaHCO₃ and Na₂HPO₄ react almost neutral.

In the case of the basic salts, not all hydroxide groups of the salt-forming bases, which hydroxide groups are dissociable in aqueous solution as hydroxide ions, are replaced by acid residues; example: basic zinc nitrate [Zn(OH)NO₃], basic aluminum acetate [Al(OH)(O—CO—CH₃₎₂] and other hydroxide salts (formerly: hydroxyl salts). The basic salts also comprise oxide salts (formerly: oxysalts) which contain acid anions as well as oxidizing oxygen; example: bismuth oxychloride (BiOCl) or SbO(NO₃). In addition, there are basic salts with a non-stoichiometric composition; example: patina.

Many salts bind crystallization water in stoichiometric proportions.

The above-mentioned simple salts are formed if an acid is neutralized by a base (or vice versa); in contrast, mixed salts form if a polyvalent base is neutralized by at least two different acids; example: chlorinated lime [Ca(OCl)Cl]. An example for the opposite case (neutralization of a polyvalent acid by at least two different bases) is magnesium ammonium phosphate (MgNH₄PO₄).

Related to the mixed salts are the double salts of the type of alum [KAl(SO₄)₂] or carnallite (MgCl₂.KCl). A very large group of salts are the complex salts. If two or more salts crystallize from solutions or melts in a simple stoichiometric ratio thereby forming a particular crystal lattice containing the ions of both salts (possibly also as a mixed crystal), then, in the meaning of the invention, in particular a double salt is obtained. When dissolving in water, double salts preferably disintegrate completely or predominantly into the ions of the salts of which they are structured. Double salts comprise kainit, alums, carnallite or ammonium iron(II) sulfate. Double salts, like amine salts, hydrates, complex salts and acid addition compounds belong to the higher-order compounds. Thus, e.g., compounds such as cryolite (sodium hexafluoroaluminate) or potassium hexachloroplatinate can be regarded as double salts or as alkaline salts of anionic hexahalogen metallates complexes.

In the meaning of the invention, complex salts are in particular ionic salts which are in particular formed from two components, the solution of which have new properties and do not show the reactions of the components used. Complex salts comprise, for example, Na₃[AlF₆]Fe³⁺, Na₃[FeF₆], [Zn(H₂O)₄]²⁺, [Fe(NH₃)₆]²⁺ or [Ba(H₂O)₈]²⁻.

Further preferred salts comprise zinc chloride (ZnCl₂), magnesium chloride (MgCl₂) and/or magnesium chloride hexahydrate (MgCl₂.6H₂O).

The substrate can preferably comprise paper, cardboard, wooden materials, composite materials, glass ceramics, textiles, laminates, leather, plastics or a combination thereof. It is further preferred that the information carrier has features and/or elements that are applied or attached and contain additional optical information, in particular printed values, symbols, characters, security or authenticity features, in particular on printed products.

It is preferred that the electrolyte is a suspension, an emulsion, a foam, a powder, a sol, an aero gel or an aerosol. In the meaning of the invention, an emulsion designates in particular a disperse system of two or a plurality of immiscible liquids. One of the liquid phases forms the dispersion agent (also: outer continuous phase) in which the other phase (also: inner or disperse phase) is dispersed in the form of fine droplets. Depending on the size of the dispersed particles and the kinetic or thermodynamic stability, they are referred to as macro (also: coarse-dispersed) and micro emulsion (also: colloid-dispersed). Here, the particle diameter fluctuates between 10⁻⁴ and 10⁻⁸ cm; however, most of the emulsions show an inconsistent particle size and are polydisperse. Depending on the size of the dispersed particles, emulsions a milky and cloudy (macro emulsion) to clear (micro emulsion).

In the meaning of the invention, a suspension designates in particular a heterogeneous mixture of substances from a liquid and solids which are finely dispersed therein and are kept in suspension in the liquid.

In the meaning of the invention, an aerosol describes in particular a colloidal system from gases (e.g. air) with small solid or liquid particles which are dispersed therein (so-called suspended solids) and have a diameter of approximately 10 μm to 1 nm. Aerosol particles can be electrically charged (e.g., through dipolar or unipolar diffusion of small ions) or can be ions themselves (e.g. created through photo effect or photo dissociation, or generated through the influence of electrical discharges). Aerosols are in particular unstable colloidal systems.

In the meaning of the invention, foam designates in particular a structure of gas-filled, spherical or polyhedral cells that are bounded by liquid, semi-liquid, highly viscous or solid cell webs. If the volume concentration of the gas at a homodispersed distribution is less than 74%, the gas bubbles are approximately spherical due to surface-reducing effect of the interfacial tension. Foams are thermodynamically unstable since by reducing the surface area, surface energy can be gained. The stability and thus existence of foam thus depends on how successfully the self-destruction of the foam can be prevented. Foams can also be fixed by solidifying the structuring substance (e.g. foamed plastics, foamed materials). Foams from low-viscosity liquids are temporarily stabilized by surfactants (e.g. tensides, foam stabilizers). Due to their large inner surface, such tenside foams have a strong adsorption capability. For generating foams, preferably, gas is blown into suitable liquids, or foam generation can be achieved by intense whipping, shaking, spraying or stirring the liquid in the appropriate gas atmosphere, provided that the liquids contain suitable tensides or other surfactants which, apart from surface activity, also exhibit a certain film forming capability.

In the meaning of the invention, a powder designates in particular a form of a dry and solid substance that is obtained by crushing, i.e., grinding or pounding in the mortar (pulverizing), milling in mills, or as a result of atomization drying or freeze-drying. A particularly fine dispersion is often called atomization or micronization. Based on the grain size, a rough classification in coarse powder, fine powder and ultra-fine powder is preferred.

In the meaning of the invention, a sol designates in particular a colloidal solution in which a finely dispersed solid or liquid substance is dispersed in a solid, liquid or gaseous medium. Gaseous dispersion media are referred to as aerosols, solid dispersion media are referred to as vitreosols and liquid ones are referred to as lyosols. Lyosols are further divided into organosols and hydrosols (example: silica sol), depending on whether a suspension in organic or aqueous phase is involved. Through coagulation, (flocculation precipitation), a sol transforms into gel, wherein possibly coacervation may occur. An aerosol designates in particular a highly porous material from silicon oxide or metal oxides.

It can also be preferred if further optical, electrical, electronic, sensory and/or acoustic elements are applied on or introduced in the information carrier. This can concern, for example, barcodes, antennas or haptic elements which likewise can be read by an appropriate reader. The function and the field of use of the information carrier are significantly expanded through these further means and make the information carrier universally usable.

Advantageously, the information carrier comprises according to a further preferred embodiment at least one cover layer that covers the substrate and/or the electrolyte completely or partially. The cover layer can advantageously be used as protection or for obliteration of the structure of the information carrier. In a preferred variant, this cover layer can also be implemented as a cover plate. The cover plate can consist of rigid or flexible materials.

It was completely surprising that in a preferred embodiment, the information carrier can be present in a flapped, folded, crimped, bent and/or flanged manner and remains fully operational.

The invention also relates to a method for producing an information carrier, comprising the following steps:
a. producing an electrolyte,
b. providing an electrically non-conductive substrate,
c. applying the electrolyte onto the substrate by means of a printing method, wherein contact between the electrolyte and the substrate is established in certain areas.

With said method, it is possible in a cost-effective and fast manner to provide an information carrier that is preferably capacitively readable. Advantageously, the information carrier can be produced using a mass printing method. The provided electrolyte can be applied onto or introduced in the substrate in a simple and fast manner by means of a printing method, wherein said electrolyte is then preferably present as a structured electrolyte layer. Printing methods are all methods by means of which electrolytes can be applied on and/or introduced in substrates. In the meaning of the invention, printing methods designate in particular methods for printing or reproducing. Printing methods comprise, for example: mechanical printing methods, photomechanical printing methods or electrostatic copying methods, in particular relief printing methods, gravure printing methods, planographic printing methods or offset printing methods.

Furthermore, it is preferred that at least one additive is admixed to the electrolyte. This makes it possible to significantly accelerate the drying process of the applied electrolyte layer, wherein the electrolyte has high stability.

Advantages of the information carrier comprise:
Can be used on absorbent as well as non-absorbent surfaces
Greater substrate inaccuracy can be tolerated
Can be applied with almost any (printing) method
Invisible
Very environmentally friendly
Extremely inexpensive
An extremely high number of materials is possible
Material is colorable
Very tolerant to bending and buckling
Can be immediately and easily overprinted; no differences in absorbency and wetting occurs on the substrate
Can be immediately individualized by means of commercially available digital printers (e.g. inkjet)
Very small quantities up to high-volume production can be implemented in this manner

The invention is now explained by means of examples, but without being limited thereto.

### EXAMPLE 1

Information carriers and the production and use thereof are already known to the person skilled in the art from WO 2010/051802, WO 2010/043422 and/or EP 10075337.5. Hereinafter, producing an information carrier is explained by way of examples, wherein the information carrier comprises an electrolyte layer, in particular a structured electrolyte layer, as a structured information layer.
1. Producing a salt solution by:
   a) filling ca. 10 g of iodized table salt (NaCl) into a container,
   b) adding ca. 40 ml of tap water,
   c) stirring and dissolving the table salt.
2. Producing an information carrier mask by:
   a) providing a film,
   b) cutting the information carrier structure (positive) according to layout A from the film by means of a scalpel→mask,
   c) glueing the mask from b) onto white copy paper (80 gr/m²).
3. Producing the information carrier by:
   a) saturating an absorbent medium (paper towel) with the salt solution from 1,
   b) dabbing the absorbed salt solution onto the affixed information carrier mask so that the salt solution saturates the underlying copy paper at the open places according to the layout A,
   c) removing the mask from the copy paper,
   d) the salt solution penetrates rapidly, the copy paper remains white without residues.
4. Testing the information carrier by means of a capacitive reading device:
   a) saturated copy paper is placed onto the capacitive reader which correctly detects the structure of the information carrier according to layout A,
   b) for a second reading trial, the information carrier is flapped, folded, crimped, bent, crumpled and/or flanged and is subsequently mechanically smoothened and read analogously to 4. a) (no to marginal errors).

For producing an information carrier according to the steps 1-3, actually, ca. 0.2 g of the solution has been used. The solution was distributed over an area of ca. 10 cm² of the copy paper. By producing an exemplary solution from 359 g of NaCl and 1000 g of water at an ambient temperature of 20° C., 1359 g of salt solution is obtained. With this simple technique, this would be sufficient for 13590 information carriers or a dabbed/printed area of 13.59 m².

Even with the aid of auxiliary materials in order to set the solution with regard to viscosity etc. for specific additive methods, an absolutely inexpensive solution for producing these information carriers is achieved.

In the meaning of the invention, additives or auxiliary materials comprise in particular:
processing agents such as dispersing agents, thickening agents and emulsifying agents,
binding agents such as hardeners (so-called co-hardeners for setting a specific property profile), solvents (e.g. so-called co-solvents in aqueous lacquers and diluents),
drying materials (siccatives),
drying agents and humectants,
aggregates, concrete admixtures
softeners
light stabilizers (UV absorbers and/or radical scavengers),
leveling agents for a lacquer surface as smooth as possible,
defoamers and deaerators,
matting agents
raising agents for foaming,
anti-skinning agents,
corrosion inhibitors, softeners and biocides,
preservatives and antioxidants,
food additives and feed additives such as minerals, vitamins and colorants,
antistatic agents,
flame retardants,
adsorbents,
diluents,
pigments,
functional fillers,
defoamers,
wetting agents,
dispersants,
thixotroping agents,
thickeners,
rheology additives,
viscosity adjusters,
primers,
separating agents,
gelling agents,
tensides and/or
photoactive substances (e.g., photoinitiators).

### EXAMPLE 2

Producing an information carrier.
1. Producing an information carrier having the layout A analogous to example 1.
2. Producing an information carrier having the layout A according to WO 2010/051802, WO 2010/043422 and/or EP 10075337.5.
3. Halving the information carrier from example 1 and halving the information carrier from point 2 by means of scissors.
4. Glueing the information carrier halves together to form layout A, which now consists of one half according to 1. and one half according to 2.
5. Reading with capacitive reader.
6. Result: a) information carrier according to layout A is detected,
   b) different qualities of the information carrier halves,
   c) selective information differentiation is possible.

Advantage: With previous technologies, only 1 or 0 can be differentiated. In contrast, it is now possible to detect 0, 1 (salt solution 1 with level 1) and 2 (cold film with level 2). This means, with the same area required, data density increases immensely.

### EXAMPLE 3

The laboratory test 2 was carried out again with a further salt solution (10 g of magnesium chloride in 40 g of water) instead of the cold film (=laboratory test 3), and the same result was obtained. Thus, selective information differences are possible. Accordingly, an information carrier according to laboratory test 2 would reveal a portion of the information in a visible manner (salt solution is invisible on paper, only cold film is visible). In the laboratory test 3, analogous to laboratory test 1, the information carrier is completely invisible, but contains 3 different status options (0, 1 and 2) of the bits. Thus, on the same area, considerably more information can be accommodated.

### EXAMPLE 4

Producing two information carriers.
1. Producing two information carriers, each having layout A, according to example 1.
2. Aligning the information carriers or the information layers and fixing them by means of adhesive tape.
3. Reading with capacitive reader
4. Result: a) information carrier according to layout A is detected,
   b) Readability/quality of the information carrier increases compared to example 1.

The invention shall now be exemplary explained with reference to the figures, but without being limited thereto. In the figures:

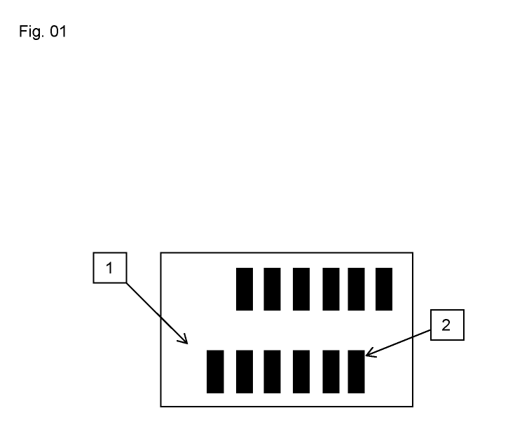

FIG. 01 shows example 1 for an information carrier having a rectangular data structure (top view),

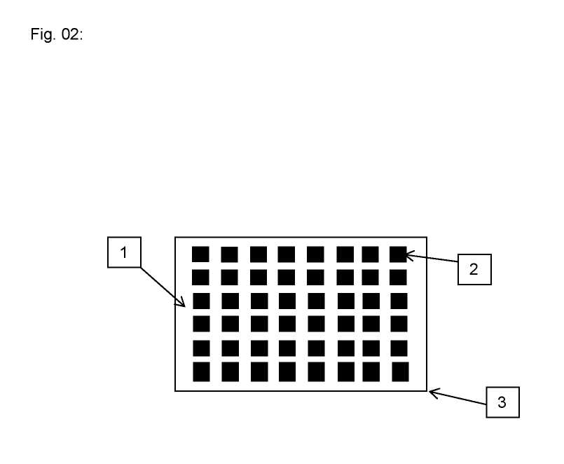

FIG. 02 shows an information carrier blank having an electrically conductive basic structure,

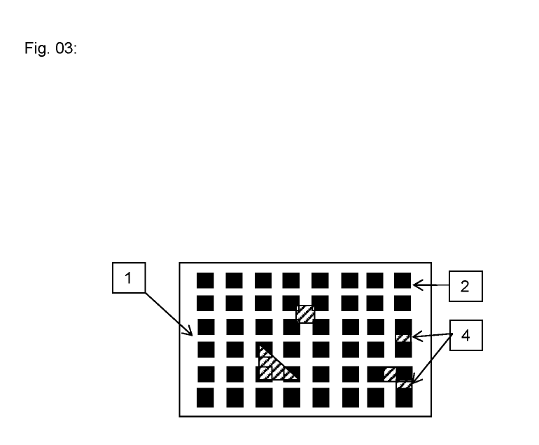

FIG. 03 shows an information carrier blank after completed individualization by means of an additive method,

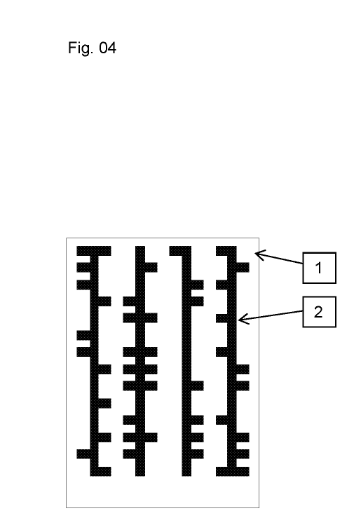

FIG. 04 shows example 2 of an information carrier,

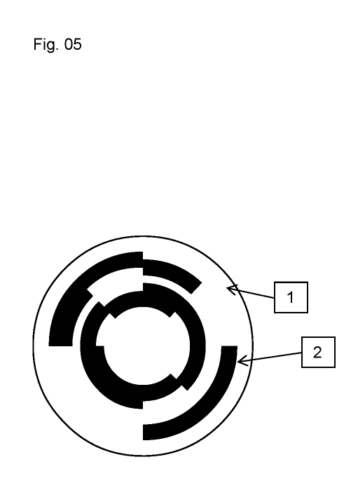

FIG. 05 shows example 3 of a round information carrier,

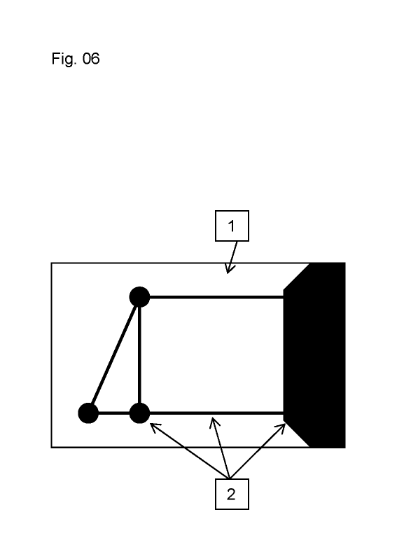

FIG. 06 shows example 4 of an information carrier,

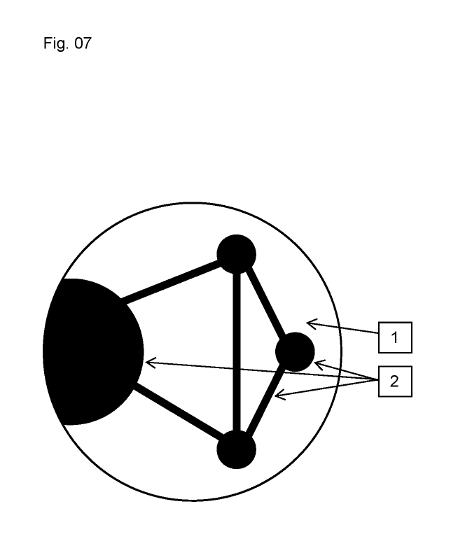

FIG. 07 shows example 5 of a round information carrier,

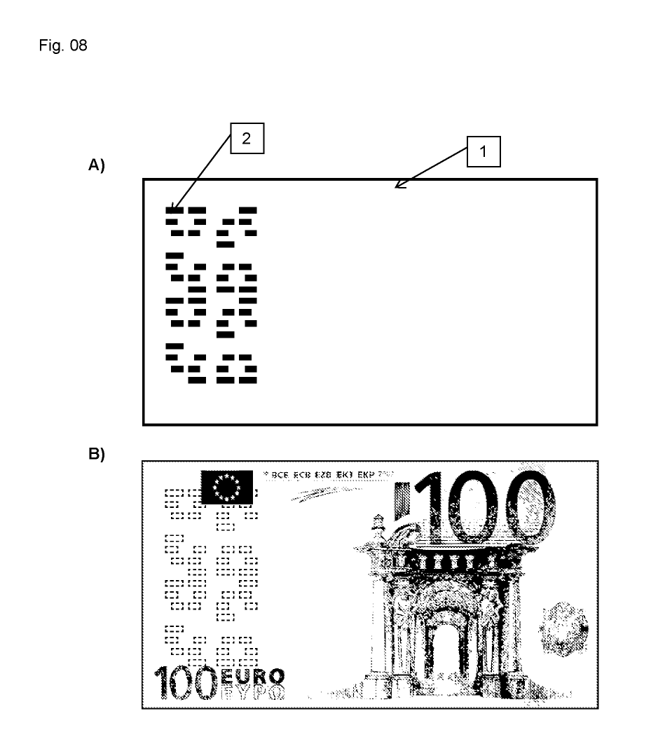

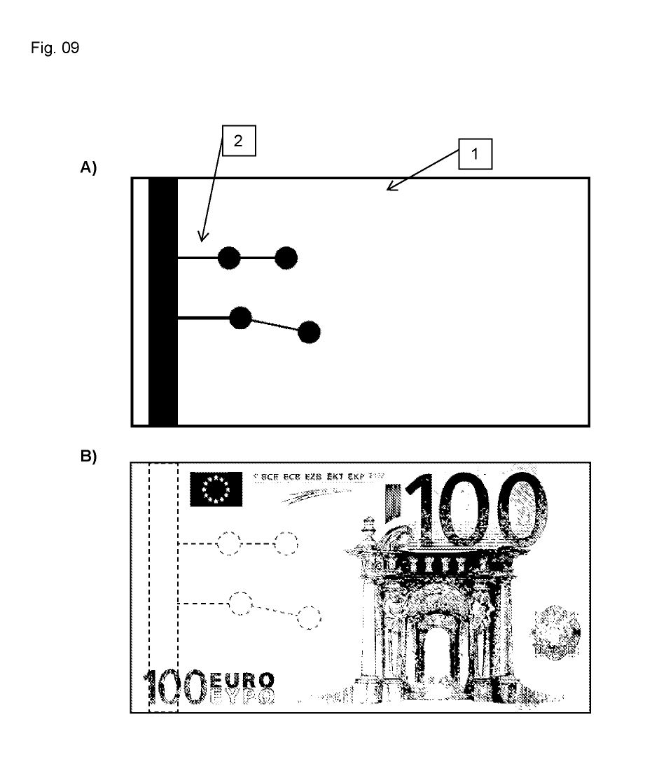

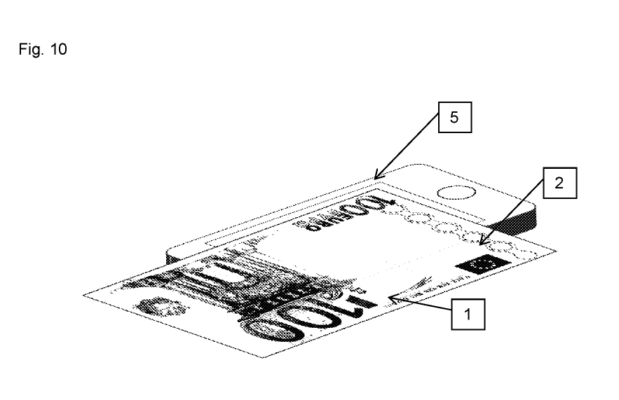

FIGS. 08-10 show an exemplary use of the information carrier.

FIG. 01 shows an information carrier according to principle 1 with a rectangular data structure (top view). A first principle is exemplary presented. Here, the substrate 1 and the structured electrolyte layer 2 (for example, in a rectangular embodiment) are illustrated.

FIG. 02 shows an information carrier blank 3 with a rectangularly structured basic structure of the electrolyte 2. Illustrated are the substrate 1 and the electrolyte layer 2.

FIG. 03 illustrates an information carrier blank 3 after completed individualization. Shown is the substrate 1, the rectangularly structured basic structure of the electrolyte layer and an additionally generated electrolyte layer 4. The additionally applied electrolyte layer 4 connects parts of the rectangularly structured basic structure.

FIG. 04 shows a further example of an information carrier. An information carrier consisting of a substrate 1 and an electrolyte layer 2 is illustrated.

FIG. 05 shows an example of a round information carrier. The information carrier preferably comprises a substrate 1 and an electrolyte layer 2.

FIG. 06 shows a further example of an information carrier. An information carrier consisting of a substrate 1 and an electrolyte layer 2 is illustrated.

FIG. 07 shows a further example of a round information carrier. The information carrier preferably comprises a substrate 1 and an electrolyte layer 2.

FIGS. 8-10 show an exemplary use of the information carrier. The information carrier, for example, can be implemented in a banknote, i.e., a bill. Here, the paper of the bill can function as a substrate 1 on or in which the electrolyte 2 is applied or introduced, respectively. Thus, the information carrier can serve as a security feature which is not visible for a user of the bill. However, it can also be preferred that the electrolyte on the bill is made completely or only partially visible by means of an additive. Accordingly, as a visible copy protection, this can serve as a deterrent. The information carrier 1 can be read by means of a reader or an area sensor so that hereby the authenticity of the bill is verified. The area sensor (e.g. a touchscreen) can be an integral part of an electrical device 5 having an area sensor. Moreover, adequate readers or applications on a device 5 comprising an area sensor can be made available, for example, to visually impaired persons, whereby verifying and also counting of bills is made possible. In this connection, the information carrier on the bill could encode the value of said bill. The bill with the information carrier is placed onto the area sensor or slid across it by means of a movement, whereby the information carrier is read by the area sensor and the data are further processed (e.g. for verifying authenticity).

### REFERENCE LIST

1 Substrate

2 Structured electrolyte layer

3 Information carrier blank

4 Additional electrolyte layer

5 Device having an area sensor

1. An information carrier, comprising
at least one electrolyte and a substrate,
wherein
the substrate is an electrically non-conductive layer and the electrolyte is applied on and/or introduced in the substrate in certain areas.

2. The information carrier according to claim 1,
wherein
the electrolyte is a salt selected from the group consisting of inorganic and organic salts, double salts, mixed salts, complex salts or combinations thereof.

3. The information carrier according to claim 1,
wherein
the electrolyte is structurally applied as a point, dash, curve, area and/or combinations thereof onto the substrate.

4. The information carrier according to claim 1,
wherein
the electrolyte is a suspension, an emulsion, a foam, a powder, a sol, an aerogel or an aerosol.

5. The information carrier according to claim 1,
wherein
the electrolyte is solid, liquid, gel-like or pasty.

6. The information carrier according to claim 1,
wherein
further optical, electrical, electronic, sensory and/or acoustic elements are applied on or introduced in the information carrier.

7. The information carrier according to claim 1,
wherein
the information carrier has at least one cover layer that covers the substrate and/or the electrolyte completely or partially.

8. The information carrier according to claim 1,
wherein
the information carrier is present in a flapped, folded, crimped, bent and/or flanged manner.

9. The information carrier according to claim 1,
wherein
the applied or introduced electrolyte is changed in certain areas via additive and/or subtractive methods, preferably by inkjet methods and particularly preferred by laser methods.

10. The information carrier according to claim 1,
wherein
features and/or elements are applied to or onto which contain additional optical information, in particular printed values, symbols, characters, security and/or authenticity features, in particular on printed products.

11. A group of information carriers, comprising a plurality of information carriers according to claim 1,
wherein
at least one paint layer, adhesive layer, paper layer and/or film is applied in each case at least as a background, cover, number, letter, character, graphic illustration and/or pictorial illustration or a combination thereof, wherein
a plurality of information carriers have an identical structure of the electrolyte and at least one identically configured paint layer so that a self-contained group of information carriers is implemented, which information carriers are identical in terms of information technology and optical appearance,
a plurality of information carriers have an identical structure of the electrolyte and at least one differently configured paint layer so that a group of information carriers is implemented, which information carriers are identical in terms of information technology, but are different in terms of optical appearance,
a plurality of information carriers have a different structure of the electrolyte and at least one identically configured paint layer so that a group of information carriers is implemented, which information carriers are more unique in terms of information technology, but are more identical in terms of optical appearance,
a plurality of information carriers have a different structure of the electrolyte and at least one differently configured paint layer so that information carriers are implemented that are unique in terms of information technology and optical appearance.

12. A method for storing information, comprising
providing the information carrier of claim 1,
wherein
the at least one electrolyte of the information carrier is structured and
the information carrier is capacitively readable.

13. The method according to claim 12,
wherein
the structured electrolyte is read by a reading device, the electrode arrangement of which is configured and arranged such that the number, size, shape and/or position of the structured electrolyte of the information carrier is detected, acquired and processed in terms of data.

14. The method according to claim 12,
wherein
the structured electrolyte is detected, acquired and processed in terms of data by an area sensor and/or a device containing an area sensor.

15. The method according to claim 12,
wherein
the information carrier is present as a security feature in or on a printed product.

16. A method for a shipment tracking comprising providing the information carrier of claim 1
wherein
the information carrier is present in printed form in or on the shipment to be tracked.

17. A system comprising a device containing an area sensor and at least one information carrier according to claim 1, wherein said at least one information carrier is brought into operative contact with the area sensor.

18. A method for producing an information carrier, comprising:
a. producing an electrolyte by mixing a salt with a liquid,
b. providing an electrically non-conductive substrate,
c. applying the electrolyte onto the substrate by means of a printing method, wherein a contact between the electrolyte and the substrate is established in certain areas.

19. The method according to claim 18, wherein at least one additive is admixed to the electrolyte.
